(19) United States
(12) Patent Application Publication
(10) Pub. No.: US 2004/0130506 A1
(43) Pub. Date: Jul. 8, 2004

(54) Image display apparatus

(75) Inventors: Masaru Ishikawa, Tokorozawa-City (JP); Takashi Nakano, Tokorozawa-City (JP); Akira Imamura, Tokorozawa-City (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 10/693,499

(22) Filed: Oct. 27, 2003

(30) Foreign Application Priority Data
Nov. 1, 2002 (JP) 2002-319680

(51) Int. Cl. G09G 3/00; H04N 9/47; H04N 13/04; H04N 15/00

(52) U.S. Cl. 345/32; 348/59

(57) ABSTRACT

An image display apparatus includes a display having an image display surface which displays a two-dimensional image of an object including a three-dimensional object, and an image transmitting panel spaced apart from the image display surface for creating an imaging plane displaying a real image of the two-dimensional image in a space opposite to the display. The image display surface exhibits a three-dimensional image which is drawn from a perspective viewpoint.

### BACKGROUND OF THE INVENTION

1) Field of the Invention

The present invention relates to an image display apparatus for displaying a two-dimensional image of an object including a three-dimensional object.

2) Description of the Related Art

In order to reproduce a three-dimensional image, a polarizing method is often used, in which a viewer wears polarizing glasses for viewing left and right parallax images based on different polarized states with respect to each other. However, such method is cumbersome for the viewer since wearing the polarizing glasses is necessary.

On the other hand, there is a known three-dimensional image display apparatus which does not use the polarizing glasses, such as a displaying method which uses a lenticular lens in order to provide viewer's eyes with parallax images corresponding to left and right images, and thus the viewer can recognize a three-dimensional image. In such apparatus, two parallax images respectively composed of strip-shaped images are alternately arranged one after another. Consequently, resolution of the image is reduced by half when displaying the three-dimensional image.

A three-dimensional image display apparatus has been proposed which utilizes polarizing means when viewing the three-dimensional image by using the lenticular lens. The polarizing means includes polarizing boards which are arranged one after another in a predetermined direction with a predetermined pitch. Each polarizing board has an individual polarizing axis which intersects at a right angle to a polarizing axis of the adjacent board. Consequently, an unnecessary reflection from a display surface is prevented and problems such as a moire and a color gap are reduced (for example, Japanese Patent Kokai No. 10-221644).

In any conventional three-dimensional image display apparatuses, the parallax images corresponding to left and right eye images are necessary from the beginning, i.e., when picking up the images of the object, and therefore, a number of means are necessary for creating such images.

In order to view the three-dimensional image using the conventional lenticular lens, utilization of a special image is necessary. The special image is made by synthesizing strip-shaped images originating from two or more images, which are respectively obtained by viewing the object from two or more directions. Accordingly, there is a need for an image display apparatus which can provide a three-dimensional image from an ordinary photograph or a picture, and thus which does not require two or more images obtained by viewing the object from two or more directions.

### SUMMARY OF THE INVENTION

An object of the present invention is to provide an image display apparatus with a simple structure which can display an image of an object including a three-dimensional object.

According to one aspect of the present invention, an image display apparatus includes a display having an image display surface which displays a two-dimensional image of an object including a three-dimensional object, and an image transmitting panel spaced apart from the image display surface for creating an imaging plane displaying a real image of the two-dimensional image in a space opposite to the display. The image display surface exhibits a three-dimensional image which is drawn from a perspective viewpoint.

### BRIEF DESCRIPTION OF THE DRAWINGS

FIG. 1 shows a schematic cross-sectional view of major elements of an image display apparatus according to an embodiment of the present invention;

FIG. 2 illustrates a front view of the image display apparatus shown in FIG. 1, which shows a displayed image; and

FIG. 3 shows a schematic perspective view of the image display apparatus shown in FIG. 1.

### DETAILED DESCRIPTION OF THE INVENTION

Embodiments of an image display apparatus for displaying a two-dimensional image of an object including a three-dimensional object according to the present invention will be hereinafter described with reference to the attached drawings.

FIG. 1 shows a schematic cross-sectional view of major elements of the image display apparatus according to one embodiment. The image display apparatus includes a display 10, and an image transmitting panel 20 supported by a support member 15 fixed to the display 10. A display panel 10a can be, for example, a color liquid crystal display panel which can display a two-dimensional image. Furthermore, the apparatus includes a driving circuit 10c connected to the display panel 10a, and an image signal supplying section 11 connected to the driving circuit 10c so as to supply an image signal of the two-dimensional image of the object including the three-dimensional object. The image transmitting panel 20 focuses the two-dimensional image in such a manner that an imaging plane 30 is created in a space opposite to the display 10 with respect to the image transmitting panel 20.

The image transmitting panel 20 includes a micro lens array 22 and a lens frame area 23 such as a lens frame, which surrounds an effective area of the micro lens array. The micro lens array 22 includes two lens array halves 24 connected to each other by the lens frame area 23 so as to form a micro convex lens board. The lens frame area 23 is supported by the support member 15. The image transmitting panel 20 is positioned spaced apart from an image display surface of the display panel 10a. The micro lens array 22 is defined as an upright image optical system having a 100% magnification which provides a viewer with a two-dimensional image of the object including an upright image. The micro lens array has an effective area larger than the image of the object which is displayed as the two-dimensional image.

The lens array half 24 includes the convex lenses 25 and a transparent flat plate 27, which are both made from, for example, acrylic. The transparent flat plate 27 may be made from light-transmissive materials such as glass. All of the convex lenses 25 are made from the same material and have the same shape. For example, the convex lenses 25 are arranged adjacent with each other in a matrix fashion on the transparent flat plate. The micro lens array 22 includes a plurality of micro lenses which are arranged two-dimensionally. Optical axes 26 of a pair of right and left convex lenses 25 coincide with each other when the convex lenses 25, respectively included in the two lens array halves 24, are juxtaposed with each other. Therefore, a plurality of lens systems are allocated two-dimensionally on the micro convex lens board, such that the optical axes of the pairs of convex lenses 25 are parallel with each other. Each of the lens systems has a pair of convex lenses 25 such that optical axes of the respective convex lenses coincide with each other. A combination of focal points of a plurality of the lens systems having the same focal lengths defines the imaging plane 30. In this embodiment, the apparatus is configured such that the image display surface of the display panel 10a is positioned within a focal depth of a plurality of the convex lenses 25, and the micro lens array 22 and the imaging plane 30 are parallel with each other. When the displaying surface of the display panel 10a for displaying the two-dimensional image is positioned outside the focal depth R of the lens or the lens system, a defocused real image is created.

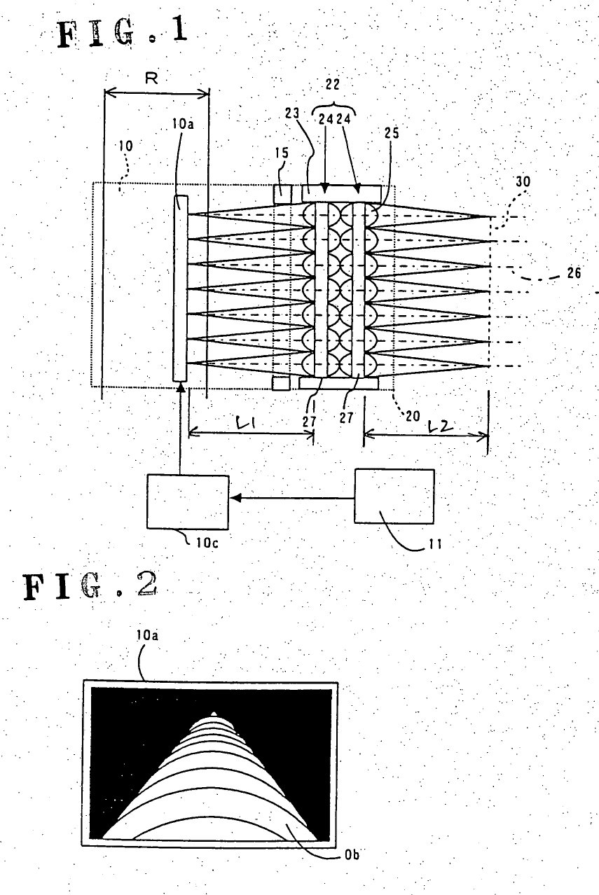

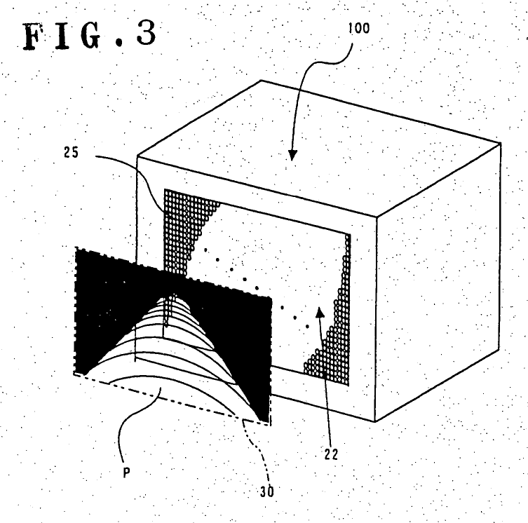

For example, when a three-dimensional image Ob having a vanishing point at an upper side, such as an image of launching a rocket, is displayed on the display panel 10a as shown in FIG. 2, a real image P of the three-dimensional image which is displayed on the imaging plane 30 by the micro lens array 22 exhibits an increased perspective feeling as shown in FIG. 3. Accordingly a viewer feels an increased three-dimensional impression. Specifically, since the three-dimensional image is drawn from a perspective viewpoint which is displayed on the image display surface of the display panel 10a, the perspective feeling is enhanced. The perspective feeling is perceived due to a psychological factor or a remembrance of an experience. In FIG. 3, the display is located in a housing 100 behind the micro lens array 22.

In this embodiment, the following examples 1-12 of the perspectives are applied for the three-dimensional images.

1. With respect to relative size of the images, a larger image shows a closer position, whereas a smaller image shows a farther position. Specifically, an object is drawn larger when the object is positioned closer to the viewer and is drawn smaller when the object is positioned farther from the viewer.

2. With respect to overlaying of images, an image in a front position shows a closer position, whereas an image in a rear position shows a farther position. Specifically, an object at a closer position to the viewer is drawn overlaying an object at a farther position from the viewer.

3. With respect to roughness and fineness of images, a rougher image shows a closer position, whereas a finer image shows a farther position. Specifically, an object is drawn rougher when the object is positioned closer to the viewer and is drawn finer when the object is positioned farther from the viewer. Furthermore, when a single object is drawn, continuous changing from a rough image to a fine image enhances the perspective feeling.

4. In order to draw an object in linear perspective, two geometrically parallel lines are drawn to meet each other so as to be directed toward a vanishing point. The number of vanishing points is either one, two or three.

5. With respect to brightness and darkness of images, a brighter image shows a closer position, whereas a darker image shows a farther position. When the gradation is expressed, the image is drawn in such a manner that the brightness changes continuously. Specifically, an object is drawn brighter when the object is positioned closer to the viewer and is drawn darker when the object is positioned farther from the viewer. When the object extends from a close site to a remote site, the object is drawn in such a manner that the brightness changes gradually from a bright image to a dark image.

6. With respect to contrast of images, a stronger contrast image shows a closer position, whereas a weaker contrast image shows a farther position. Specifically, an object is drawn with a stronger contrast when the object is positioned closer to the viewer and is drawn with a weaker contrast when the object is positioned farther from the viewer.

7. With respect to chromaticness of images, a more vivid image shows a closer position, whereas a duller or less vivid image shows a farther position. Specifically, an object is drawn more vivid when the object is positioned closer to the viewer and is drawn duller when the object is positioned farther from the viewer.

8. With respect to hue of images, a red (warm) image shows a closer position, whereas a blue (cold) image shows a farther position. Specifically, an object is drawn by warmer color such as red when the object is positioned closer to the viewer and is drawn by colder color such as blue when the object is positioned farther from the viewer.

9. With respect to resolution of images, a higher resolution image shows a closer position, whereas a lower resolution image shows a farther position. Specifically, an object is drawn with a higher resolution when the object is positioned closer to the viewer and is drawn with a less resolution when the object is positioned farther from the viewer.

10. With respect to shade and shadow of images, the perspective feeling is perceived by the brain based on the remembrance of everyday experiences. Therefore, the light is drawn as originating from above. Specifically, light comes to the object from above, and a shade and shadow is drawn below the object.

11. With respect to motion parallax of images, a faster moving image shows a closer position, whereas a slower moving image shows a farther position. Specifically, an object is drawn to move faster when the object is positioned closer to the viewer and is drawn to move slower when the object is positioned farther from the viewer.

12. The perspective can be expressed by combining the above-described methods 1-11.

When the curvature of the convex lens 25 provided on the left side (input side) is smaller than the curvature of the convex lens 25 provided on the right side (output side) with respect to a pair of lenses respectively included in the lens array halves 24, the distance between the display panel 10a and the lens surface of the left side lens array half 24, L1, becomes shorter than the distance between the imaging plane 30 and the lens surface of the right side lens array half 24, L2, as shown in FIG. 1. This configuration thus achieves a sufficient distance between the imaging plane 30 and the image transmitting panel 20, and provides the image display apparatus having a compact depth (thickness).

It should be noted that the display panel 10a of the display 10 is not limited to the color liquid crystal display panel. For example, display apparatuses such as a cathode ray tube, a plasma display or an organic electroluminescence display may be utilized. Moreover, the display panel 10a may include an enlarged image display surface of a flat shape such as a positive print or a positive film for a slide projector, or a reversal film prepared by applying a transparent color-printing on a transparent film, and a back lighting unit for back illumination. The image display apparatus may further include a second display such as a reversal film which is positioned between the imaging plane 30 and the image transmitting panel 20.

As described above, the image display surface of the display 10, i.e., the display panel 10a, is positioned within a depth of field in the vicinity of the object side focal plane, which is defined by the micro lens array 22 of the image transmitting panel 20. When the object image is displayed on the image display surface of the display 10, the image is focused on the imaging plane 30 on or in the vicinity of the image side focal plane. Accordingly, a real image of the object can be viewed from the approximate direction of the optical axis. Since a reproduced real image is obtained from the object image displayed on the image display surface of the display 10, the image display surface side is the object side.

This application is based on a Japanese patent application No. 2002-319680 which is incorporated herein by reference.

What is claimed is:

1. An image display apparatus comprising:
a display having an image display surface which displays a two-dimensional image of an object including a three-dimensional object; and
an image transmitting panel spaced apart from the image display surface for creating an imaging plane displaying a real image of the two-dimensional image in a space opposite to the display;
wherein the image display surface exhibits a three-dimensional image which is drawn from a perspective viewpoint.

2. The image display apparatus according to claim 1, wherein the image transmitting panel includes a micro lens board having an array of a plurality of micro lenses arranged two-dimensionally, the micro lenses define at least one lens system, each lens system having a pair of convex lenses coaxial with each other, and optical axes of the lens systems are parallel with each other.

3. The image display apparatus according to claim 2, wherein the image display surface of the display is positioned within a focal depth of the plurality of lenses.

4. The image display apparatus according to claim 1, wherein an object is drawn larger when the object is positioned closer to a viewer and is drawn smaller when the object is positioned farther from the viewer in the three-dimensional image drawn from a perspective viewpoint.

5. The image display apparatus according to claim 1, wherein an object at a closer position to a viewer is drawn overlaying an object at a farther position from the viewer in the three-dimensional image drawn from a perspective viewpoint.

6. The image display apparatus according to claim 1, wherein an object is drawn rougher when the object is positioned closer to a viewer and is drawn finer when the object is positioned farther from the viewer in the three-dimensional image drawn from a perspective viewpoint.

7. The image display apparatus according to claim 1, wherein an object is drawn in such a manner that the image is continuously changed from rough to fine when a single object is displayed as the three-dimensional image.

8. The image display apparatus according to claim 1, wherein an object is drawn to have one, two or three vanishing points in the three-dimensional image drawn from a perspective viewpoint.

9. The image display apparatus according to claim 1, wherein an object is drawn brighter when the object is positioned closer to a viewer and is drawn darker when the object is positioned farther from the viewer, and the object is drawn in such a manner that brightness of the image changes gradually from bright to dark, so as to make gradation, when the object extends from a close site to a remote site in the three-dimensional image drawn from a perspective viewpoint.

10. The image display apparatus according to claim 1, wherein an object is drawn with a stronger contrast when the object is positioned closer to a viewer and is drawn with a weaker contrast when the object is positioned farther from the viewer in the three-dimensional image drawn from a perspective viewpoint.

11. The image display apparatus according to claim 1, wherein an object is drawn more vivid when the object is positioned closer to a viewer and is drawn less vivid when the object is positioned farther from the viewer in the three-dimensional image drawn from a perspective viewpoint.

12. The image display apparatus according to claim 1, wherein an object is drawn by use of warmer color such as red when the object is positioned closer to a viewer and is drawn by use of colder color such as blue when the object is positioned farther from the viewer in the three-dimensional image drawn from a perspective viewpoint.

13. The image display apparatus according to claim 1, wherein an object is drawn with a higher resolution when the object is positioned closer to a viewer and is drawn with a less resolution when the object is positioned farther from the viewer in the three-dimensional image drawn from a perspective viewpoint.

14. The image display apparatus according to claim 1, wherein light comes to the object from above and a shade and shadow is drawn below the object in the three-dimensional image drawn from a perspective viewpoint.

15. The image display apparatus according to claim 1, wherein an object is drawn so as to move faster when the object is positioned closer to a viewer and is drawn so as to move slower when the object is positioned farther from the viewer in the three-dimensional image drawn from a perspective viewpoint.

16. An image display apparatus comprising:
first means for displaying a two-dimensional image of an object including a three-dimensional object, the first means having an image display surface; and
second means for creating an imaging plane displaying a real image of the two-dimensional image in a space opposite to the first means;
wherein the image display surface exhibits a three-dimensional image which is drawn from a perspective viewpoint.

17. The image display apparatus according to claim 16, wherein the second means includes a micro lens board having an array of a plurality of micro lenses arranged two-dimensionally, the micro lenses define at least one lens system, each lens system having a pair of convex lenses coaxial with each other, and optical axes of the lens systems are parallel with each other.

18. The image display apparatus according to claim 17, wherein the image display surface of the first means is positioned within a focal depth of the plurality of lenses.

19. The image display apparatus according to claim 16, wherein an object is drawn larger when the object is positioned closer to a viewer and is drawn smaller when the object is positioned farther from the viewer in the three-dimensional image drawn from a perspective viewpoint.

20. The image display apparatus according to claim 16, wherein an object at a closer position to a viewer is drawn overlaying an object at a farther position from the viewer in the three-dimensional image drawn from a perspective viewpoint.
